(19) United States
(12) Patent Application Publication
(10) Pub. No.: US 2008/0016029 A1
(43) Pub. Date: Jan. 17, 2008

(54) OPTIMIZING A QUERY TO A DATABASE

(76) Inventors: Mariam John, Austin, TX (US); Nader W. Moussa, Cary, NC (US); Sushima B. Patel, Austin, TX (US); Gregory Studer, Macungie, PA (US); Jacob E. Yackenovich, Morrisville, NC (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/456,638

(22) Filed: Jul. 11, 2006

(51) Int. Cl. G06F 17/30

(52) U.S. Cl. 707/2

(57) ABSTRACT

Methods, apparatus, and computer program products are disclosed for optimizing a query to a database that includes identifying types of nodes in the database, identifying relationships among the types of nodes, and creating an access plan in dependence upon the types of nodes and the relationships among the types of nodes. Optimizing a query to a database may also include creating a representative node for each type. Optimizing a query to a database may also include identifying a relationship between a node of each type and a node of another type. Optimizing a query to a database may also include identifying a relationship between a node of each type and a node of the same type. Optimizing a query to a database may also include creating an access plan that excludes unrelated nodes.

### BACKGROUND OF THE INVENTION

1. Field of the Invention

The field of the invention is data processing, or, more specifically, methods, apparatus, and products for optimizing a query to a database.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database may be implemented as a group of nodes where each node is an aggregation of data. Nodes may be used to represent any component or characteristic of a component in a system such as, for example, a computing machine, operating system, applications, network location, geography, and so on. Relationships among the nodes represent the relationships among the components and characteristics of components in a system. A database typically implements nodes using structures called ‘rows.’ A row is a group of associated data elements often referred to as ‘columns’ or ‘fields.’ A row is often referred to as a ‘record.’

A computer system typically operates according to computer program instructions in computer programs. A computer program that supports access to information in a database is typically called a database management system or a ‘DBMS.’ A DBMS is responsible for helping other computer programs access, manipulate, and save information in a database.

A DBMS typically supports access and management tools to aid users, developers, and other programs in accessing information in a database. One such tool is the structured query language (‘SQL’). SQL is query language for requesting information from a database. Although there is a standard of the American National Standards Institute (‘ANSI’) for SQL, as a practical matter, most versions of SQL tend to include many extensions. Here is an example of a database query expressed in SQL:
select * from stores, transactions
where stores.location=“Raleigh”
and stores.storeID=transactions.storeID

This SQL query accesses information in a database by selecting records from two tables of the database, one table named ‘stores’ and another table named ‘transactions.’ The records selected are those having value “Raleigh” in the records' store location fields and transactions for the stores in Raleigh. To retrieve the result for the SQL query above, the DBMS generates a number of ‘primitive queries,’ each primitive query used to retrieve a portion of the data needed to satisfy the SQL query. In retrieving the data for the exemplary SQL query, an SQL engine will first use a primitive query generated by the DBMS to retrieve records from the stores table and then use another primitive query to retrieve records from the transaction table. Records that satisfy the primitive query requirements then are merged in a ‘join’ and returned as a result of the SQL require received by the DBMS.

To calculate the result of a query, many primitive queries for nodes in a database are often required. The number of primitive queries required frequently depends on the number of relationships that must be traversed among nodes to calculate the result of the query. When the web of nodes in the database is large, as is often the case, the number of primitive queries required to return a result for a query may be quite large. In addition, the number of nodes returned by each primitive query to the database may also increase dramatically as the graph of the database is broadened.

Large numbers of primitive queries often results in poor search performance in a database when only a higher-level information about the types of nodes which are connected to one another is required. Currently, searches for such higher-level information about the types of nodes in a graph of a database can be performed using standard graph search algorithms that start at the root nodes and proceed level by level through the relationships of the nodes, where each level requires a primitive query. Standard graph search algorithms of this type, however, use significant amounts of computer resources that often make such searches costly.

### SUMMARY OF THE INVENTION

Methods, apparatus, and computer program products are disclosed for optimizing a query to a database that includes identifying types of nodes in the database, identifying relationships among the types of nodes, and creating an access plan in dependence upon the types of nodes and the relationships among the types of nodes. Optimizing a query to a database may also include creating a representative node for each type. Optimizing a query to a database may also include identifying a relationship between a node of each type and a node of another type. Optimizing a query to a database may also include identifying a relationship between a node of each type and a node of the same type. Optimizing a query to a database may also include creating an access plan that excludes unrelated nodes.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an exemplary system for optimizing a query to a database according to embodiments of the present invention.

FIG. 2 sets forth a block diagram of automated computing machinery comprising an exemplary computer useful in optimizing a query to a database according to embodiments of the present invention.

FIG. 3 sets forth a flow chart illustrating an exemplary method for optimizing a query to a database according to embodiments of the present invention.

FIG. 4 sets forth a flow chart illustrating a further exemplary method for optimizing a query to a database according to embodiments of the present invention.

FIG. 5 sets forth a flow chart illustrating a further exemplary method for optimizing a query to a database according to embodiments of the present invention.

### DETAILED DESCRIPTION OF EXEMPLARY EMBODIMENTS

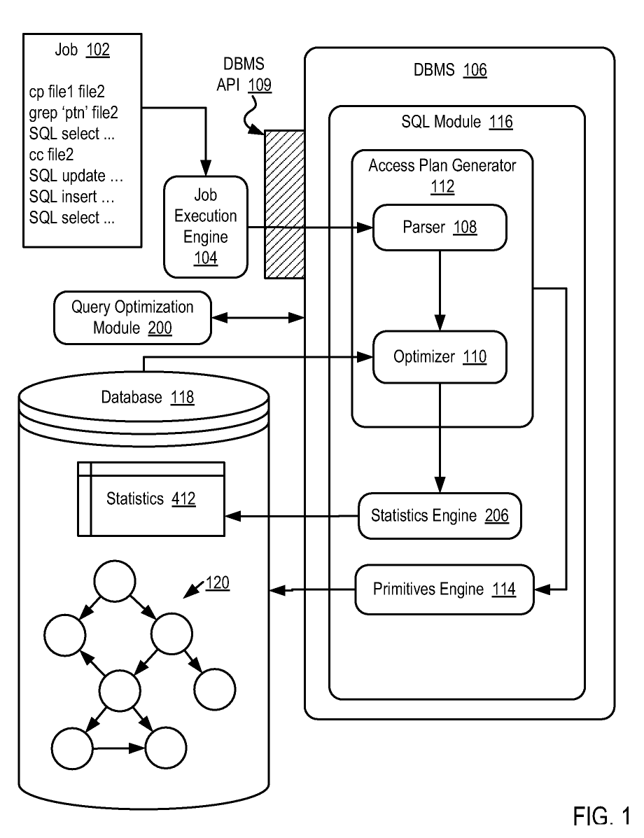

Exemplary methods, apparatus, and products for optimizing a query to a database according to embodiments of the present invention are described with reference to the accompanying drawings, beginning with FIG. 1. FIG. 1 sets forth a block diagram of an exemplary system for optimizing a query to a database according to embodiments of the present invention. The system of FIG. 1 operates generally for optimizing a query to a database according to embodiments of the present invention by identifying types of nodes in the database, identifying relationships among the types of nodes, and creating an access plan in dependence upon the types of nodes and the relationships among the types of nodes.

As mentioned above, a node is an aggregation of data and may be implemented as, for example, a record of a table in a database. Although a particular database may implement nodes as records of a table, such implementations are for explanation and not for limitation. In fact, nodes useful in optimizing a query to a database may be implemented as objects of a class in an object-oriented environment, blocks of data in sequential storage, or any other aggregation of data as will occur to those of skill in the art.

In the example of FIG. 1, nodes (120) may be used to represent any component or characteristic of a component in a system. Consider, for example, a database having nodes representing a network computer system where a first server is installed in Austin and a second server is installed in Raleigh. The first server has an IP address of ‘155.143.153.110,’ the second server has an IP address of ‘133.152.124.106,’ and both servers have the Linux operating system installed upon them. In such an example, one node may represent each of the following: ‘first server,’ ‘second server,’ ‘Austin,’ ‘Raleigh,’ ‘Linux,’ ‘155.143.153.110,’ and ‘133.152.124.106.’ The relationships between components in the exemplary network computer system may be represented by the relationships between nodes. For example, to represent the relationships that the ‘first server’ has with other components of the exemplary system, the ‘first server’ node will have a relationship with the ‘Austin’ node, a relationship with the ‘Linux’ node, and a relationship with the ‘155.143.153.110’ node.

A type of node represents nodes having a common characteristic. That is, a type of node represents a sort of ‘super node’ composed of characteristics common to all nodes in a particular group. When a database implements a node as a record of a table, a type of node may represent the table containing the node because all the nodes in the table make up a group of nodes having common data fields. When a database implements a node as an object of a class in an object-oriented environment, a type of node may represent the class of which the node is an instance because all the nodes instantiated from a particular class make up a group of nodes having common data elements and methods. Although the above discussion explains types of nodes in the context of tables and objects in an object-oriented environment, such a discussion is for explanation and not for limitation. In fact, other characteristics that a group of nodes have in common may also be used to specify a type of node such as, for example, a node attribute, a value for a node attribute, the size of a node, and so on.

The exemplary system of FIG. 1 includes a DBMS (106) to provide access tools and management tools to aid users, developers, and other programs in accessing nodes (120) in database (1 18). Access and management tools provided by DBMS (106) may be implemented as software modules inside the DBMS. In the exemplary system of FIG. 1, DBMS (106) includes a SQL module (116). SQL module (116) is implemented as computer program instructions that execute a SQL query against the nodes (120) of database (118).

In the exemplary system of FIG. 1, SQL module (116) receives SQL queries for execution from job execution engine (104). Job execution engine (104) is a software module that executes jobs, such as job (102), by passing commands from the jobs to software applications appropriate to the command. Jobs may mingle SQL queries with other commands to perform various data processing tasks. Job (102), for example, includes several commands for execution as part of job (102), including:
“cp file1 file2,” an operating system command to copy one file to another file,
“grep ‘ptn’ file2,” a general regular expression command of the operating system to find occurrences of ‘ptn’ in file ‘file2’,
“cc file2,” a command to compile file ‘file2’ as a C program, and
several SQL commands, each of which passes call parameters identifying a SQL query to an executable command identified as ‘SQL.’

In this example, job execution engine (104) will pass the operating system commands from job (102) to an operating system for execution and pass the SQL queries from job (102) to SQL module (116) for execution. Job execution engine (104) passes the SQL queries to SQL module (116) through an application programming interface (‘API’) (109) of database management system (‘DBMS’) (106). DBMS (106) exposes DBMS API (109) to enable applications, such as, for example, job execution engine (104), to access modules of the DBMS, such as, for example, SQL module (116). The ‘SQL’ command illustrated in job (102) is an exemplary function exposed through DBMS API (109).

In the exemplary system of FIG. 1, SQL module (116) includes access plan generator (112). An access plan is a sequence of database operations for carrying out a query to the database. The access plan generator (112) of FIG. 1 is implemented as computer program instructions that create an access plan for a SQL query. An access plan is a description of database functions for execution of an SQL query. Taking the following SQL query as an example:
select * from stores, transactions
where stores.storeID=transactions.storeID,
   access plan generator (112) may generate the following exemplary access plan for the exemplary SQL query above:
tablescan stores
join to
index access of transactions

This access plan represents database functions that are carried out by primitive queries to the database. In the example above, the DBMS uses primitive queries to scan through the stores table and, for each stores record, join all transactions records for the store. The transactions for a store in the transaction table are identified through the ‘storeID’ field serving as a foreign key. The fact that a selection of transactions records is carried out for each store record in the stores table identifies the join function as iterative.

The exemplary access plan generator (112) of FIG. 1 includes a parser (108) for parsing the SQL query. Parser (108) is implemented as computer program instructions that parse the SQL query. A SQL query is presented to SQL module (116) in text form as the parameters of a SQL command. Parser (108) retrieves the elements of the SQL query from the text form of the query and places them in a data structure more useful for data processing of a SQL query by SQL module (116).

In the exemplary system of FIG. 1, access plan generator (112) also includes an optimizer (110) implemented as computer program instructions that optimize the access plan in dependence upon database management statistics (412). Database statistics may reveal, for example, that there are only two values for ‘storeID’ in the transactions table—so that it is more efficient to scan the transactions table rather than using an index to locate records with a particular value for ‘storeID.’

Alternatively, database statistics may reveal that there are many transaction records with only a few transactions records for each value for ‘storeID’—so that it is more efficient to access the transactions records by an index.

Database statistics are typically implemented as metadata of a table, such as, for example, metadata of tables containing nodes (120) of database (118). Database statistics may include, for example:
Histogram statistics: a histogram range and a count of values in the range,
Frequency statistics: a frequency of occurrence of a value in a column, and
Cardinality statistics: a count of the number of different values in a column.

These three database statistics are presented for explanation only, not for limitation. The use of any database statistics as will occur to those of skill in the art is well within the scope of the present invention. When the optimizer attempts to use databases statistics for a column of a table, for example, and finds the database statistics missing or stale, the optimizer (110) notifies statistics engine (206). Statistics engine (206) then generates the missing or stale statistics.

In addition to the optimizer (110), the exemplary system of FIG. 1 also includes query optimization module (200) that communicates with DBMS (106) for optimizing a query to a database according to embodiments of the present invention. The query optimization module (200) may communicate with the DBMS (106) through an inter-process communication API of an operating system or exposing query optimization module API to the DBMS (106). Although the exemplary system of FIG. 1 depicts the query optimization module (200) logically separate from the DBMS (106), such a depiction is for explanation and not for limitation. The query optimization module (200) may, in fact, be a component logically included within the DBMS (106) or any component of the DBMS (106) such as, for example, the optimizer (110).

In the exemplary system of FIG. 1, the query optimization module (200) is a set of computer program instructions improved for optimizing a query to a database according to embodiments of the present invention. The query optimization module (200) operates generally by identifying types of nodes in the database, identifying relationships among the types of nodes, and creating an access plan in dependence upon the types of nodes and the relationships among the types of nodes. Query optimization module (200) operates to optimize a query to a database according to embodiments of the present invention using node type data that stores information regarding the types of nodes in the database (118) and information regarding the relationships among the types of nodes as discussed in more detail below

In the exemplary system of FIG. 1, the exemplary SQL module (116) includes a primitives engine (114) implemented as computer program instructions that execute primitive query functions in dependence upon the access plan. A ‘primitive query function,’ or simply a ‘primitive,’ is a software function that carries out actual operations on a database, retrieving records from tables, inserting records into tables, deleting records from tables, updating records in tables, and so on. Primitives correspond to parts of an access plan and are identified in the access plan. Examples of primitives include the following database instructions:
retrieve the next three records from the stores table into hash table H1
retrieve one record from the transactions table into hash table H2
join the results of the previous two operations
store the result of the join in table T1

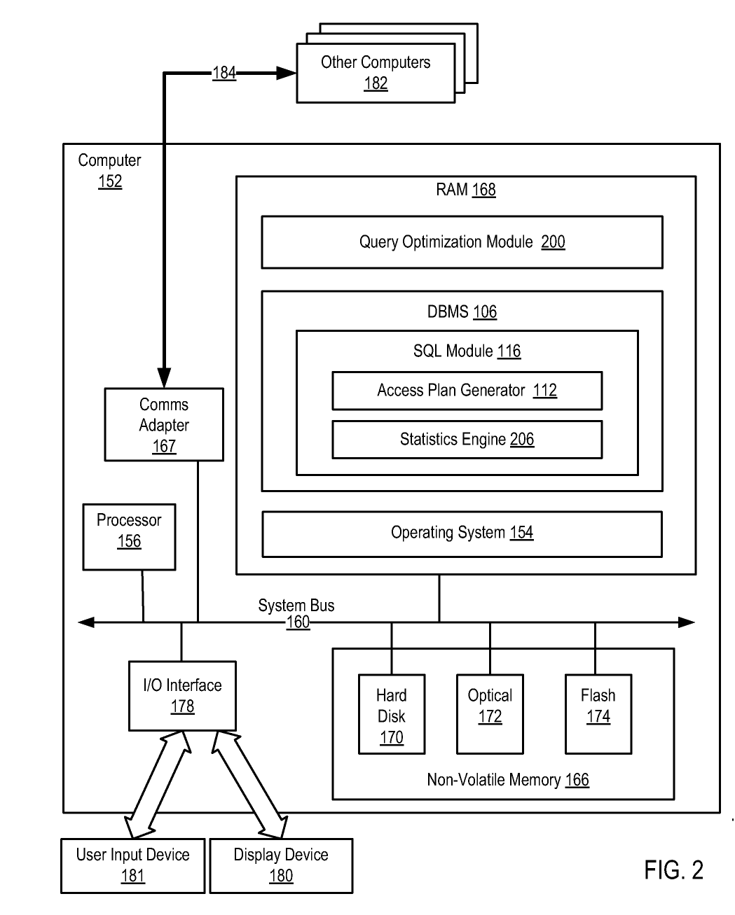

Optimizing a query to a database in accordance with the present invention is generally implemented with computers, that is, with automated computing machinery. All the components in the exemplary system of FIG. 1, for example, are implemented to some extent at least with computers. For further explanation, therefore, FIG. 2 sets forth a block diagram of automated computing machinery comprising an exemplary computer (152) useful in optimizing a query to a database according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is DBMS (106), computer program instructions for database management. The DBMS (106) of FIG. 2 includes an SQL module (116), which in turn includes an access plan generator (112) and a statistics engine (206), each of which implement computer program instructions stored in RAM (168) that operate computer (152) as described above. Also stored in RAM (168) is query optimization module (200). Query optimization module (200) is a set of computer program instructions improved for optimizing a query to a database according to embodiments of the present invention by identifying types of nodes in the database, identifying relationships among the types of nodes, and creating an access plan in dependence upon the types of nodes and the relationships among the types of nodes.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), DBMS (106), and query optimization module (200) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for optimizing a query to a database according to embodiments of the present invention include modems for wired dial-up communications, Ethernet (IEEE 802.3) adapters for wired network communications, and 802.11b adapters for wireless network communications.

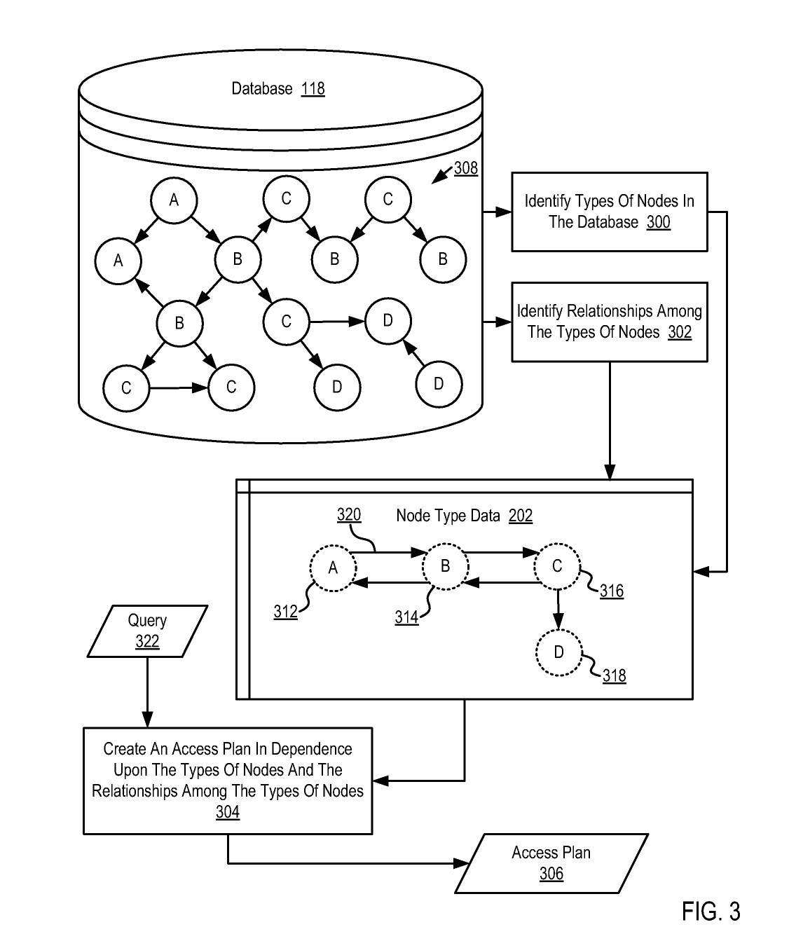

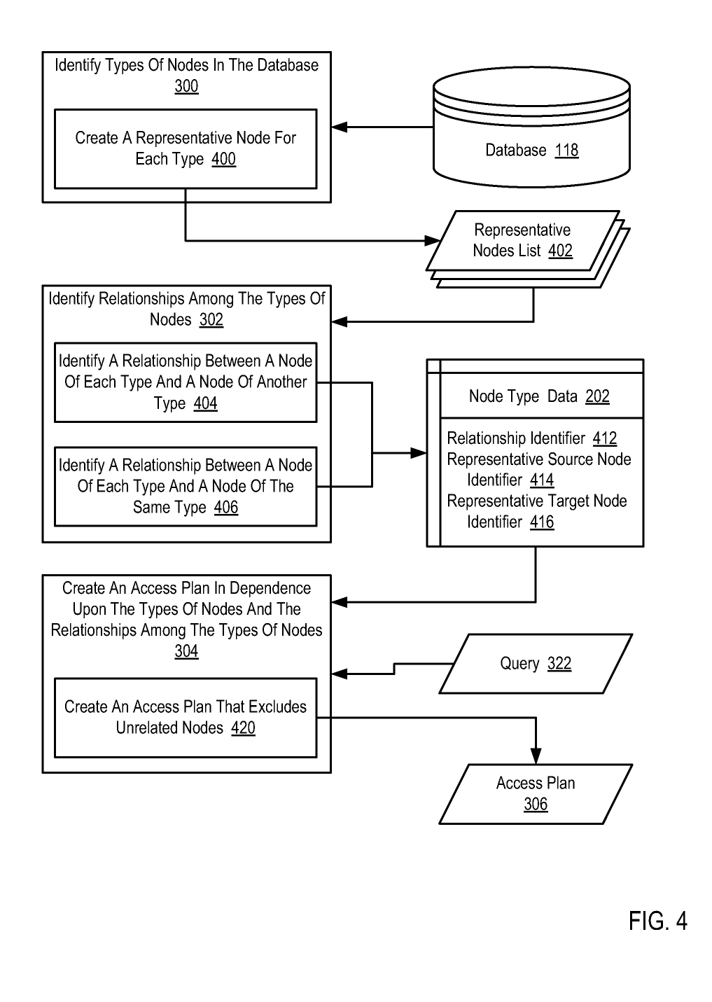

For further explanation, FIG. 3 sets forth a flow chart illustrating an exemplary method for optimizing a query to a database according to embodiments of the present invention. The method of FIG. 3 includes identifying (300) types of nodes in the database (118). In the example of FIG. 3, the database (118) includes a number of nodes (308) having relationships among one another. Each node (308) in database (118) is of a particular type. The type of each node is identified by a letter inside of each node. For example, nodes labeled with the letter ‘A’ are of a type ‘A.’ Nodes labeled with the letter ‘B’ are of a type ‘B.’ Nodes labeled with the letter ‘C’ are of a type ‘C.’ Nodes labeled with the letter ‘D’ are of a type ‘D.’ In the method of FIG. 3, identifying (300) types of nodes in the database (118) may be carried out by creating a representative node for each type of node as discussed below with reference to FIG. 4.

Identifying (300) types of nodes in the database (118) according to the example of FIG. 3 results in the identification of node type data (202) useful in optimizing a query to a database according to embodiments of the present invention. Node type data (202) includes information regarding the types of nodes in the database and information regarding the relationships among the types of nodes. In the example of FIG. 3, node type data (202) is represented as a record including types (312, 314, 316, 318) that indicate at least one of the nodes (308) in database (118) exists for each type (312, 314, 316, 318). FIG. 3 depicts the types (312, 314, 316, 318) of nodes using dotted lines to distinguish the types from the actual nodes (308) of that type stored in database (118). In the example of FIG. 3, type (312) represents the type of node identified by letter ‘A,’ or type ‘A.’ Type (314) represents the type of node identified by letter ‘B,’ or type ‘B.’ Type (316) represents the type of node identified by letter ‘C,’ or type ‘C.’ Type (318) represents the type of node identified by letter ‘D,’ or type ‘D.’

For further explanation, consider again, the example above where the nodes of a database represent a network computer system having a first server installed in Austin and a second server is installed in Raleigh. In such an example, identifying (300) types of nodes may result in the following types: computer hardware, geography, operating system, and a network address. In this example, computer hardware is the type of node representing the ‘first server’ and ‘second server’ nodes. Geography is the type of node representing the ‘Austin’ and the ‘Raleigh’ nodes. Operating system is the type of node representing the ‘Linux’ node. Network address is the type of node representing the ‘155.143.153.110’ and ‘133.152.124.106’ nodes.

The method of FIG. 3 also includes identifying (302) relationships among the types of nodes. The relationships among the types of nodes represent the relationships among the nodes (308) in the database (118). A relationship among types of nodes in node type data (202) represents that at least one identical relationship exists in the database (118) among the nodes of the types having the relationship in node type data (202). For example, the relationship (320) among type ‘A’ (312) and type ‘B’ (314) in node type data (202) represents that at least one identical relationship exists in database (118) among nodes (308) of the types ‘A’ and ‘B.’ The relationship (320) among type ‘A’ (312) and type ‘B’ (314) in node type data (202) is identical to a relationship among nodes (308) in database (118) in that the relationship between types ‘A’ and ‘B’ (312, 314) and the relationship between nodes (308) in database (118) have the same characteristics such as, for example, the type of the relationship, the direction of the relationship, the attributes of the relationship, and so on. For example, nodes (308) of the type ‘A’ and ‘B’ in database (118) have a relationship where a node of type ‘A’ is the source of the relationship and node of type ‘B’ is the target of the relationship. In node type data (202), therefore, type ‘A’ has a relationship with type ‘B’ where type ‘A’ is the source of the relationship and type ‘B’ is the target of the relationship.

For further explanation, consider again the example above where the nodes of a database represent a network computer system having a first server installed in Austin and a second server is installed in Raleigh. In such an example, identifying (302) relationships among the types of nodes results in a relationship between the computer hardware type and the geography type because the ‘first server’ node has a relationship with the ‘Austin’ node. Identifying (302) relationships among the types of nodes in this example also results in a relationship between the computer hardware type and the network address type, a relationship between the computer hardware type and the operating system type. Identifying (302) relationships among the types of nodes in this example, however, does not result in a relationship between the geography type and the operating system type because the ‘Linux’ node does not have a relationship with either the ‘Austin’ node or the ‘Raleigh’ node.

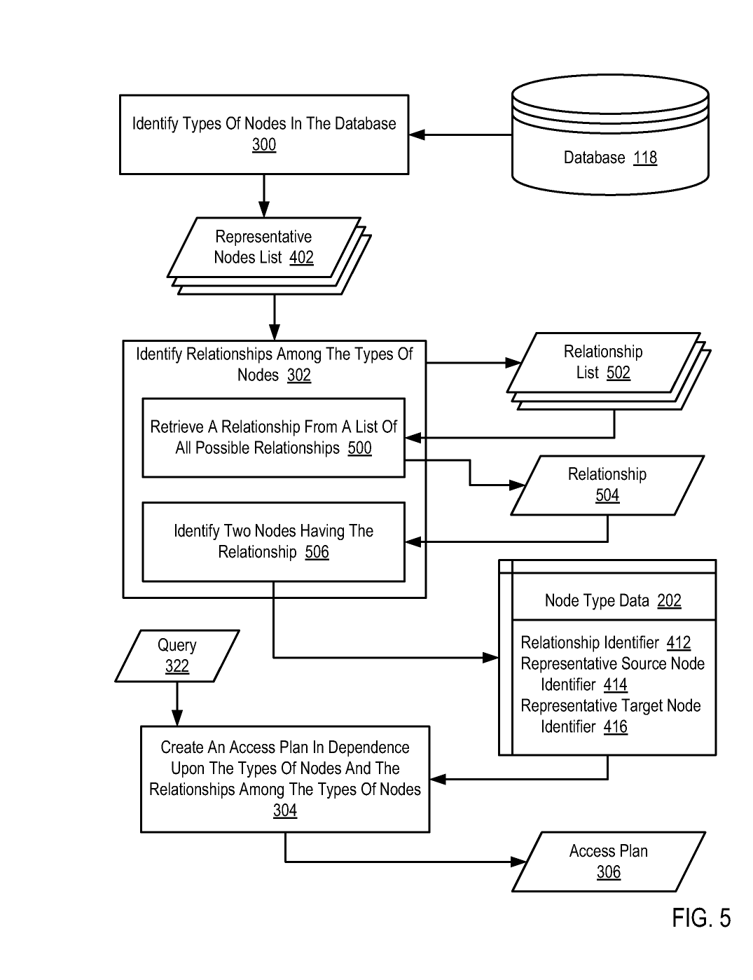

In the method of FIG. 3, identifying (302) relationships among the types of nodes may be carried out by identifying a relationship between a node of each type and a node of another type, identifying a relationship between a node of each type and a node of the same type, retrieving a relationship from a list of all possible relationships, or identifying two nodes having the relationship as discussed below with reference to FIGS. 4 and 5. Identifying (302) relationships among the types of nodes in such a manner advantageously allows for optimizing a query to a database using a node-based approach or a relationship-based approach.

The method of FIG. 3 also includes creating (304) an access plan (306) in dependence upon the types of nodes and the relationships among the types of nodes. Access plan (306) represents a sequence of database operations for carrying out a query (322) to a database. Creating (304) an access plan (306) in dependence upon the types of nodes and the relationships among the types of nodes may be carried out by creating an access plan that excludes unrelated nodes as discussed below with reference to FIG. 4.

Continuing with the example above where the nodes of a database represent a network computer system having a first server installed in Austin and a second server is installed in Raleigh, consider that a user queries the database for nodes having a relationship to a network address. An access plan for such an exemplary query may be created that excludes traversing through the operating system type of nodes and the geography type of nodes because the network address type of nodes only has a relationship with the computer hardware type of nodes. That is, the access plan would specify queries only for nodes of the computer hardware type. Creating (304) an access plan (306) in dependence upon the types of nodes and the relationships among the types of nodes according to the method of FIG. 3, therefore, reduce the number of primitive queries required to calculate the result of the user's query for nodes having a relationship to a network address.

Now consider another exemplary query to the exemplary database that represents a network computer system having a first server installed in Austin and a second server installed in Raleigh. In such an example, a user queries the database for whether a relationship exists between a node of the computer system type and a node of a geography type. Creating (304) an access plan (306) in dependence upon the types of nodes and the relationships among the types of nodes according to the method of FIG. 3 may result in an access plan for such an exemplary query that specifies a primitive query only for the relationships among the types of nodes. Because a relationship between the computer system type and the geography type indicate that at least one relationship exists among the nodes of the database between a node of the computer system type and a node of a geography type, one query for the relationships among the types of nodes provides the information needed to calculate the result of the user's query. That is, a primitive query of the actual data nodes of the database does not need to be included in the access plan.

As mentioned above, identifying types of nodes in the database may be carried out by creating a representative node for each type. For further explanation, therefore, FIG. 4 sets forth a flow chart illustrating a further exemplary method for optimizing a query to a database according to embodiments of the present invention that includes identifying (300) types of nodes in the database (118) that is carried out by creating (400) a representative node for each type. A representative node is a node that represents all nodes of a particular type. That is, the representative node is a sort of ‘metanode’ that describes all the nodes of a particular type. For example, a representative node may represent all the nodes in a particular table of a database, all the nodes instantiated from a particular class in an object oriented environment, all the nodes having a particular value for an attribute, and so on. Creating (400) a representative node (402) for each type may be carried out by traversing the database (118) using an iterative or recursive algorithm to identify the type of each node in the database (118), and creating a new node in a representative nodes list (402) for each new type identified.

The method of FIG. 4 also includes identifying (302) relationships among the types of nodes. Identifying (302) relationships among the types of nodes includes identifying (404) a relationship between a node of each type and a node of another type. Identifying (404) a relationship between a node of each type and a node of another type may be carried out by querying the database (118) for all nodes that have a relationship with a node represented by the first representative node in the representative node list (402) and where the returned nodes themselves are not represented by first representative node in the representative node list (402). For example, if the first representative node represents nodes of type ‘A,’ then identifying (404) a relationship between a node of each type and a node of another type may be carried out by querying the database for nodes of type ‘B,’‘C,’ ‘D,’ etc. that have relationships with a node of type ‘A.’ To ensure that all relationships between nodes of type ‘A’ and nodes of another type are identified, querying the database (118) for all nodes that have a relationship with a node represented by the first representative node in the representative node list (402) may be carried out iteratively using each node in the database (118) that is represented by the first representative node in the representative node list (402).

After querying the database (118) for all nodes that have a relationship with a node represented by the first representative node in the representative node list (402), identifying (404) a relationship between a node of each type and a node of another type may further be carried out by querying the database (118) for all nodes that have a relationship with a node represented by the second representative node in the representative node list (402) and where the returned nodes themselves are not represented by second representative node in the representative node list (402) in a manner similar to the manner described above using the first representative node in the representative node list (402). In this manner, identifying (404) a relationship between a node of each type and a node of another type according to the method of FIG. 4 may be iteratively carried out using each representative node in the representative node list (402).

For each unique relationship identified above between a node of each type and a node of another type, identifying (404) a relationship between a node of each type and a node of another type according to the method of FIG. 4 may further be carried out by storing the identifiers of the two representative nodes from the representative nodes list (402) representing the nodes having the identified relationship in a record representing node type data (202). Identifying (404) a relationship between a node of each type and a node of another type according to the method of FIG. 4 may also be carried out by storing the identifier of the relationship in a record representing node type data (202).

In the example of FIG. 4, node type data (202) is implemented as a table that associates a relationship identifier (412), a representative source node identifier (414), and a representative target node identifier (416). The relationship identifier (412) represents information about the relationship between the two representative nodes such as, for example, the type of relationship, the number of nodes in the database (118) having a similar relationship, attributes of the relationship, and so on. Representative source node identifier (414) represents the representative node in the representative node list (402) serving as the source of the relationship represented by the associated relationship identifier (412). Representative target node identifier (416) represents the representative node in the representative node list (402) serving as the target of the relationship represented by the associated relationship identifier (412). Distinguishing a representative node as the source or target of an identified relationship is meaningful in the context of a directional relationship. Some relationships, however, are not directional. In the context of non-directional relationships, the identifier of a representative node in an identified relationship may be stored in either the representative source node identifier (414) or the representative target node identifier (416) of node type data (202) without regard to whether the representative node is the source or target of the relationship.

In the method of FIG. 4, identifying (302) relationships among the types of nodes may also be carried out by identifying (406) a relationship between a node of each type and a node of the same type. Identifying (406) a relationship between a node of each type and a node of the same type may be carried out by querying the database (118) for all nodes represented by the first representative node in the representative node list (402) that have a relationship with a node represented by the first representative node. For example, if the first representative node represents nodes of type ‘A,’ then identifying (406) a relationship between a node of each type and a node of the same type may be carried out by querying the database for nodes of type ‘A’ that have relationships with a node of type ‘A.’ To ensure that all relationships between nodes of type ‘A’ are identified, querying the database (118) for all nodes represented by the first representative node in the representative node list (402) that have a relationship with a node represented by the first representative node may be carried out iteratively using each node in the database (118) that is represented by the first representative node in the representative node list (402).

After querying the database (118) for all nodes represented by the first representative node in the representative node list (402) that have a relationship with a node represented by the first representative node, identifying (406) a relationship between a node of each type and a node of the same type may further be carried out by querying the database (118) for all nodes represented by the second representative node in the representative node list (402) that have a relationship with a node represented by the second representative node in a manner similar to the manner described above using the first representative node. In the method of FIG. 4, identifying (406) a relationship between a node of each type and a node of the same type may be iteratively carried out using each representative node in the representative node list (402).

For each unique relationship identified above between a node of each type and a node of the same type, identifying (406) a relationship between a node of each type and a node of the same type according to the method of FIG. 4 may further be carried out by storing the identifier of the representative node from the representative nodes list (402) representing the nodes having the identified relationship in node type data (202). Identifying (406) a relationship between a node of each type and a node of the same type according to the method of FIG. 4 may also be carried out by storing the identifier of the relationship in a record representing node type data (202).

The method of FIG. 4 also includes creating (304) an access plan (306) in dependence upon the types of nodes and the relationships among the types of nodes.

Creating (304) an access plan (306) in dependence upon the types of nodes and the relationships among the types of nodes includes creating (420) an access plan that excludes unrelated nodes. Creating (420) an access plan that excludes unrelated nodes may be carried out by generating an access plan to execute query (322) that excludes querying database (118) for nodes represented by a first representative node having relationships with nodes represented by a second representative node when the first representative node does not have a relationship with the second representative node in node type data (202). Consider, for example, that a first representative node representing all nodes of type ‘A’ does not have a relationship with a second representative node representing all nodes of type ‘B’ in node type data (202). Creating (420) an access plan that excludes unrelated nodes may, therefore, be carried out by generating an access plan to execute query that excludes querying database for nodes of type ‘A’ having a relationship with nodes of type ‘B’ because no such relationship exists in the database.

Readers will note that in the method of FIG. 4 identifying relationships among the types of nodes is carried out by identifying a relationship between a node of each type and a node of another type, and identifying a relationship between a node of each type and a node of the same type. As mentioned above, identifying relationships among the types of nodes may also be carried out by retrieving a relationship from a list of all possible relationships and identifying two nodes having the relationship. For further explanation, therefore, FIG. 5 sets forth a flow chart illustrating a further exemplary method for optimizing a query to a database according to embodiments of the present invention that includes retrieving (500) a relationship from a list of all possible relationships and identifying (506) two nodes having the relationship. The method of FIG. 5 is similar to the method of FIG. 4 in that the method of FIG. 5 includes identifying (300) types of nodes in the database (118), identifying (302) relationships among the types of nodes, and creating (304) an access plan (306) in dependence upon the types of nodes and the relationships among the types of nodes.

In the method of FIG. 5, identifying (302) relationships among the types of nodes may be carried out by creating a list (502) of all possible relationships between types of nodes in the database (118). Creating a list (502) of all possible relationships between types of nodes in the database (118) may be carried out by traversing the representative node list (402) and adding a relationship to the list (502) of all possible relationships between each representative node in the representative node list (402) and all of the other representative nodes in the representative node list (402).

In the method of FIG. 5, identifying (302) relationships among the types of nodes includes retrieving (500) a relationship from the list (502) of all possible relationships and identifying (506) two nodes having the relationship. The relationship (504) represents a relationship between types of nodes in the database (118) retrieved from the list (502) of all possible relationships. Identifying (506) two nodes having the relationship may be carried out by querying the database (118) for all nodes of one of the types included in relationship (504), and then querying the database (118) for a node of the other type included in the relationship (504) having a relationship with each of the nodes returned in the first query until two nodes having the relationship (504) are identified.

When two nodes having the relationship (504) are identified, identifying (506) two nodes having the relationship may further be carried out by storing the identifiers of the two representative nodes from the representative nodes list (402) having the relationship (504) in a record representing node type data (202). Identifying (506) two nodes having the relationship according to the method of FIG. 5 may also be carried out by storing the identifier of the relationship (504) in a record representing node type data (202). In the method of FIG. 5, retrieving (500) a relationship from the list (502) of all possible relationships and identifying (506) two nodes having the relationship may be iteratively carried out for each relationship (504) in the list (502) of all possible relationships.

In the method of FIG. 5, creating (304) an access plan (306) in dependence upon the types of nodes and the relationships among the types of nodes may be carried out by creating an access plan that excludes unrelated nodes in the manner described above with reference to FIG. 4. As mentioned above, an access plan (306) represents a sequence of database operations for carrying out a query (322) to a database.

Readers will note that optimizing a query to a database according to embodiments of the present invention reduces the overall cost, in terms of computer resources, of a query to a database. Although identifying (300) types of nodes in the database and identifying (302) relationships among the types of nodes generally requires traversing the entire database to obtain data regarding the relationships among types of nodes in a database, these steps may occur infrequently or may occur at times when the cost of querying the database is low such as, for example, at night or on weekends. After identifying (300) types of nodes in the database and identifying (302) relationships among the types of nodes occurs, creating (304) an access plan (306) in dependence upon the types of nodes and the relationships among the types of nodes may be carried out over and over again to leverage the data regarding the relationships among types of nodes in a database by creating access plans that exclude unrelated nodes. Optimizing a query to a database according to the methods of FIGS. 3, 4, and 5, therefore, advantageously reduces the number of queries specified in an access plan and reduces the overall cost of a query to a database.

Exemplary embodiments of the present invention are described largely in the context of a fully functional computer system for optimizing a query to a database. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for optimizing a query to a database, the method comprising:
identifying types of nodes in the database;
identifying relationships among the types of nodes; and
creating an access plan in dependence upon the types of nodes and the relationships among the types of nodes.

2. The method of claim 1 wherein identifying the types of nodes in the database further comprises creating a representative node for each type.

3. The method of claim 1 wherein identifying the relationships among the types of nodes further comprises identifying a relationship between a node of each type and a node of another type.

4. The method of claim 1 wherein identifying the relationships among the types of nodes further comprises identifying a relationship between a node of each type and a node of the same type.

5. The method of claim 1 wherein identifying the relationships among the types of nodes further comprises:
retrieving a relationship from a list of all possible relationships; and
identifying two nodes having the relationship.

6. The method of claims 1 wherein creating the access plan in dependence upon the types of nodes and the relationships among the types of nodes further comprises creating an access plan that excludes unrelated nodes.

7. An apparatus for optimizing a query to a database, the apparatus comprising a computer processor, a computer memory operatively coupled to the computer processor, the computer memory having disposed within it computer program instructions capable of:
identifying types of nodes in the database;
identifying relationships among the types of nodes; and
creating an access plan in dependence upon the types of nodes and the relationships among the types of nodes.

8. The apparatus of claim 7 wherein identifying the types of nodes in the database further comprises creating a representative node for each type.

9. The apparatus of claim 7 wherein identifying the relationships among the types of nodes further comprises identifying a relationship between a node of each type and a node of another type.

10. The apparatus of claim 7 wherein identifying the relationships among the types of nodes further comprises identifying a relationship between a node of each type and a node of the same type.

11. The apparatus of claim 7 wherein identifying the relationships among the types of nodes further comprises:
retrieving a relationship from a list of all possible relationships; and
identifying two nodes having the relationship.

12. The apparatus of claim 7 wherein creating the access plan in dependence upon the types of nodes and the relationships among the types of nodes further comprises creating an access plan that excludes unrelated nodes.

13. A computer program product for optimizing a query to a database, the computer program product disposed upon a signal bearing medium, the computer program product comprising computer program instructions capable of:
identifying types of nodes in the database;
identifying relationships among the types of nodes; and
creating an access plan in dependence upon the types of nodes and the relationships among the types of nodes.

14. The computer program product of claim 13 wherein the signal bearing medium comprises a recordable medium.

15. The computer program product of claim 13 wherein the signal bearing medium comprises a transmission medium.

16. The computer program product of claim 13 wherein identifying the types of nodes in the database further comprises creating a representative node for each type.

17. The computer program product of claim 13 wherein identifying the relationships among the types of nodes further comprises identifying a relationship between a node of each type and a node of another type.

18. The computer program product of claim 13 wherein identifying the relationships among the types of nodes further comprises identifying a relationship between a node of each type and a node of the same type.

19. The computer program product of claim 13 wherein identifying the relationships among the types of nodes further comprises:
retrieving a relationship from a list of all possible relationships; and
identifying two nodes having the relationship.

20. The computer program product of claim 13 wherein creating the access plan in dependence upon the types of nodes and the relationships among the types of nodes further comprises creating an access plan that excludes unrelated nodes.
